(19) United States
(12) Patent Application Publication
(10) Pub. No.: US 2014/0380347 A1
(43) Pub. Date: Dec. 25, 2014

(54) METHODS AND SYSTEMS FOR USER EXPERIENCE BASED CONTENT CONSUMPTION

(71) Applicant: WeFi Inc., Marlborough, MA (US)

(72) Inventors: Eran Naveh, Washington, DC (US); Alexander Zaidelson, Rehovot (IL); David Fishman, Denver, CO (US); Zur Feldman, Hadar Am (IL)

(73) Assignee: WeFi Inc., Marlborough, MA (US)

(21) Appl. No.: 14/296,786

(22) Filed: Jun. 5, 2014

Related U.S. Application Data
(60) Provisional application No. 61/838,477, filed on Jun. 24, 2013.

(51) Int. Cl. H04N 21/466; H04N 21/435; H04N 21/462; H04N 21/442

(52) U.S. Cl. CPC H04N 21/4667; H04N 21/44204; H04N 21/435; H04N 21/4622
USPC 725/14

(57) ABSTRACT

Computer-implemented methods, systems, and computer readable media are disclosed for user experience based content consumption. The computer-implemented methods include, for example, receiving a request reflecting a content consumption of a content item. The computer-implemented methods may also include determining, using at least one processor, an alternative content consumption associated with an improved user experience than the requested content consumption as a function of historical experience data. In addition, the computer-implemented methods may also include outputting data associated with the alternative content consumption.

### RELATED APPLICATION

The present application claims the benefit of U.S. Provisional Application No. 61/838,477, filed Jun. 24, 2013, the entirety of which is incorporated herein by reference.

### TECHNICAL FIELD

The present disclosure relates to the field of content consumption and, more particularly, methods and systems for consuming content based on historical experience data.

### BACKGROUND

Devices such as mobile telephones and laptops are often configured to access content stored remotely (e.g., content stored on or associated with a website) using a wireless network connection. Such content can include a variety of types of data such as music, videos, and other media.

The experience of a user that consumes content may vary based on a number of factors such as, for example, the quality of a network connection used to access content and the hardware used to play, or otherwise consume, the content. For example, the time it takes for a video or music file to begin playing on the user's device, the bitrate of a video or music file, the number of times a video or music file playback needs to pause, restart, or stall and move into a mode called “buffering,” and the duration of any such buffering, may affect the user experience.

Improvements in techniques for consuming content, including techniques for taking into account past user experiences of content consumption, are desirable.

### SUMMARY

In one disclosed embodiment, a computer-implemented method for user experience based content consumption is disclosed. The method comprises receiving a request reflecting a content consumption of a content item, determining, using at least one processor, an alternative content consumption associated with an improved user experience than the requested content consumption as a function of historical experience data, and outputting data associated with the alternative content consumption.

In another disclosed embodiment, a system for user experience based content consumption is disclosed. The system comprises at least one processor and at least one memory devices that includes instructions which, when executed by the at least one processor, configure the at least one processor to receive a request reflecting a content consumption of a content item, determine an alternative content consumption associated with an improved user experience than the requested content consumption as a function of historical experience data, and output data associated with the alternative content consumption.

In another disclosed embodiment, a non-transitory computer-readable medium is disclosed. The non-transitory computer-readable medium comprises instructions that, when executed by at least one processor, cause the at least one processor to perform operations. The operations include receiving a request reflecting a content consumption of a content item, determining an alternative content consumption associated with an improved user experience than the requested content consumption as a function of historical experience data, and outputting data associated with the alternative content consumption.

Additional aspects related to the embodiments will be set forth in part in the description which follows, and in part will be obvious from the description, or may be learned by practice of the embodiments of the present disclosure.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several exemplary embodiments.

FIG. 1 illustrates an example geographical region in accordance with some of the disclosed embodiments.

FIG. 2 illustrates an example system that may be used for implementing the disclosed embodiments.

FIG. 3 illustrates an example device that may be used for implementing the disclosed embodiments.

FIG. 4 illustrates an example content consumption method for implementing the disclosed embodiments.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Systems, methods, and computer-readable media are described that enable historical experience data regarding consumption of content to be processed, analyzed, and utilized to influence subsequent content consumption. For example, systems, methods, and computer-readable media are described in which networked devices request and receive content items from content sources. The networked devices may determine various metrics regarding the consumption of a content item, such as the startup delay, the number of buffering events, and the duration of buffering events. A networked device may send a report regarding the consumption of a content item to another device, such as a server, which may aggregate a plurality of reports to generate historical experience data. The historical experience data may subsequently be used when a request for a content item is made, for example, to propose an alternative content item that is associated with improved user experiences.

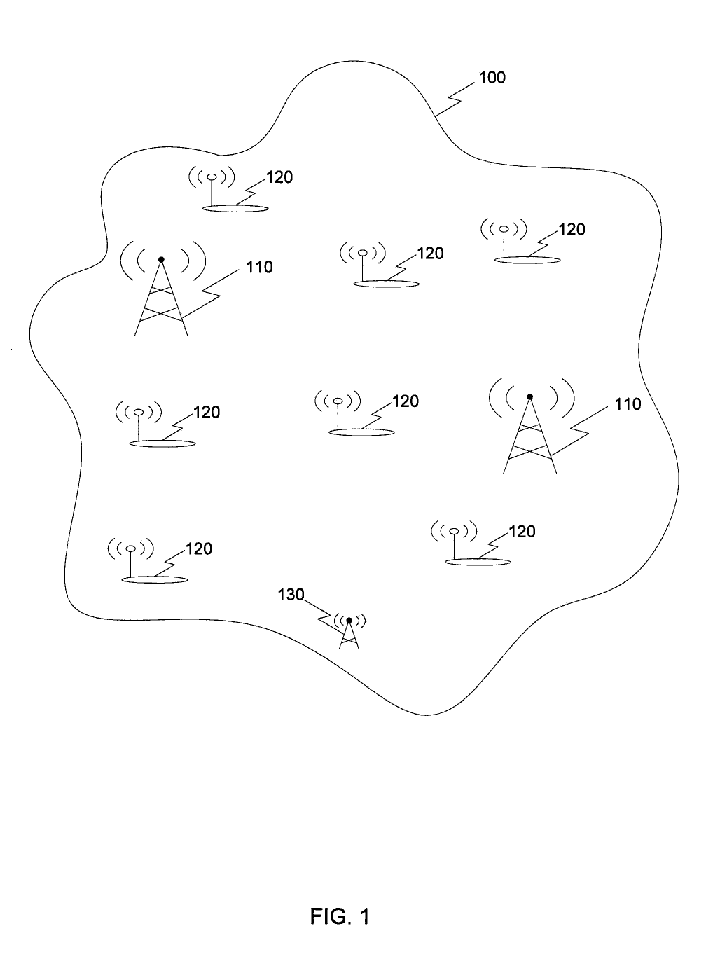

FIG. 1 is a diagram illustrating an example geographic region 100 according to some disclosed embodiments. Geographic region 100 may be, for example, an area within a city, state, or country, or any other geographical area. In some embodiments, geographical region 100 comprises a number of transceivers 110 configured to manage communications in a cellular network protocol, a number of transceivers 120 configured to manage communications in a WLAN network protocol, and a number of other transceivers, such as, for example, transceivers 130 configured to manage communications in a small cell network. In some embodiments, the area serviced (i.e., the area provided wireless network coverage) by one or more cellular networks' transceivers 110, one or more WLAN networks' transceivers 120, and/or one or more other transceivers, can overlap. For example, a cellular transceiver 110 may provide cellular network coverage for a first area and a WLAN transceiver 120 may provide WLAN network coverage for a second area that at least partially overlaps the first area.

Each of the one or more cellular transceivers 110 may be operated by the same network provider or different network providers. Similarly, each of the WLAN transceivers 120 may be operated by the same network provider or different network providers. And each of the small cell network transceivers 130 may be operated by the same network provider or different network providers. Thus, for example, a first small cell network transceiver 130 operated by a first network provider and a second small cell network transceiver 130 operated by a second network provider may provide network coverage for areas that at least partially overlap. While FIG. 1 depicts a specific number of cellular transceivers 110, WLAN transceivers 120, and small cell network transceivers 130, in some embodiments geographical region 100 includes any number of cellular transceivers 110, WLAN transceivers 120, and small cell network transceivers 130, including no cellular transceivers 110, WLAN transceivers 120, or small cell network transceivers 130.

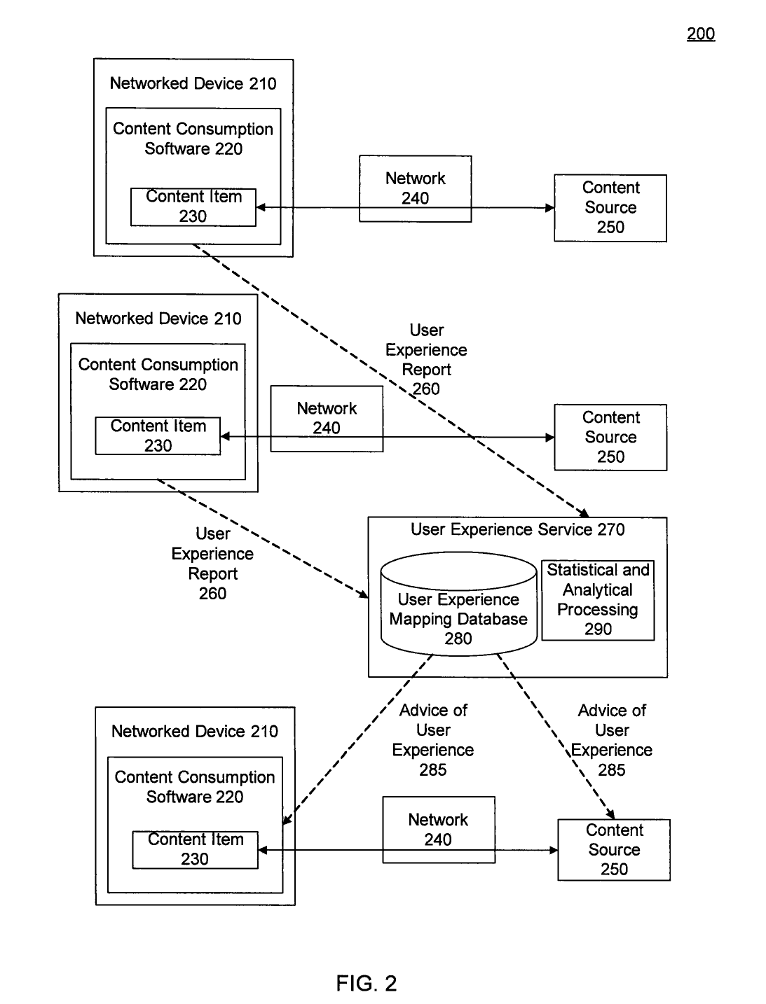

FIG. 2 is a diagram illustrating an example system 200 that may be used to implement the disclosed embodiments. In some embodiments, system 200 includes, among other things, a networked device 210, a content source 250, and a user experience service 270.

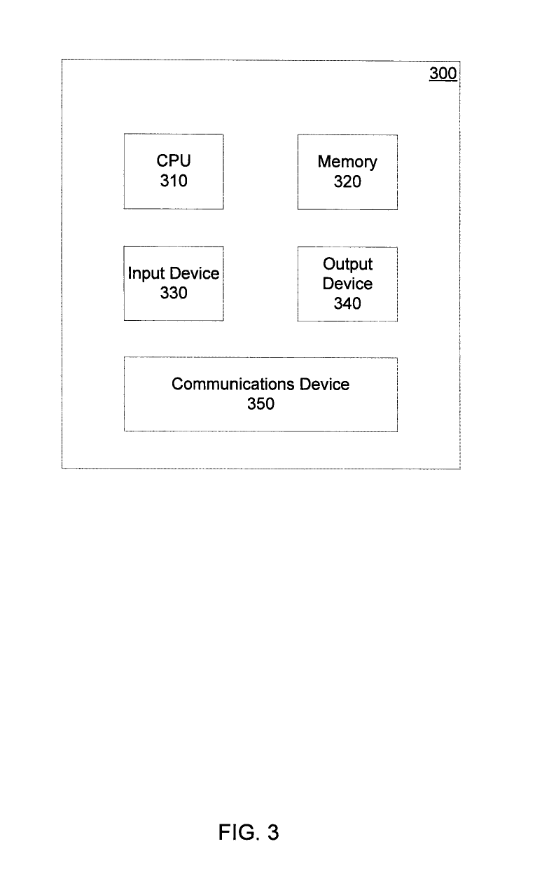

Networked device 210 is configured, for example, in accordance with device 300 shown in FIG. 3. Device 300 may include, among other things, one or more of the following components: a central processing unit (CPU) 310 configured to execute computer program code to perform various processes and methods, including the embodiments herein described; memory 320, such as RAM, EEPROM, and flash memory, to store data and computer program code; an input device 330 configured to receive user input, such as a keyboard, mouse, touchscreen, microphone, or camera; an output device 340 configured to provide user output, such as a display (e.g., a touchscreen display) or speaker; and a communications device 350 configured to enable data communication with other components, such as a cellular transceiver, WLAN transceiver, and network interface controller (NIC).

Content source 250 is configured, for example, similarly or the same as device 300 (e.g., including some or all of the components of device 300 described above). For example, content source 250 may include memory 320 having data of a variety of content, such as video (e.g., movies), audio (e.g., music), text, and pictures. The content may be stored in a variety of file formats and bitrates. For example, video files may be stored as MPEG, AVI, M4V, WMV, or any other video file format. One or more files may be stored in each format for one or more different resolutions, including but not limited to SD (360p), HD (720p), Full HD (1080p), etc. . . . . Audio files may be stored as, for example, MP3, WAV, WMA, or any other audio file format. One or more files may be stored in each format for one or more different audio bitrates, including but not limited to lossy encoding with bitrates of 32 Kbps, 128 Kbps, 256 kbps, and lossless encoding. Picture files may be stored as, for example, JPEG, TIFF, GIF, or any other picture file format. For each format, files may be stored in one or more compression levels. Text files may be stored as, for example, DOC, PDF, or any other text file format. Moreover, the content may be stored in an unencrypted format or an encrypted format. If the content is stored in an encrypted format, the content may be decrypted prior to being sent from content source 250 to another component (e.g., networked device 210) or may be sent in an encrypted format.

Networked device 210 may be configured to access one or more content sources 250 via a network connection such as network 240. For example, a user may request a content item 230 using content consumption software 220 running on networked device 210. Content consumption, as used herein, may refer to any output of data associated with a content item. Content consumption software 220 may include, for example, any software that, when executed by networked device 210, may configure networked device 210 to output data associated with content item 230 (e.g., output audio data associated with a song file or video data associated with a video file).

Networked device 210 may be configured to transmit a request for content item 230 to content source 250 via network 240. In some embodiments, network 240 may include any type of wireless network, such as those discussed above (e.g., cellular network, WLAN network, or small cell network). Network 240 may also be a wired network. Moreover, within the same system, some networked devices 210 may utilize wireless networks whereas other networked devices 210 may utilize wired networks. Based on a received request for content item 230, content source 250 may transmit content item 230 to networked device 210 via a network such as network 240. In some embodiments, networked device 210 may have a choice of multiple different networks to use to transmit requests and/or to receive content items. For example, networked device 210 may be configured to utilize both a cellular network and a WLAN network, and may choose a particular network based on a variety of factors such as user experience (e.g., a described in more detail below).

Networked device 210 may also be configured to transmit one or more user experience reports 260 to user experience service 270 based on consumption of content item 230. User experience report 260 may include, for example, one or more of information identifying content item 230, the network used by networked device 210 to consume content item 230, the time that content item 230 was consumed, the location of networked device 210 at the time of consumption, and/or one or more relevant user experience metrics. For example, a user experience metric may include one or more of data representative of startup delay, data representative of a number of buffering events, and/or data representative of a duration of buffering events.

Startup delay, for example, represents the time it takes from a request for content item 230 being sent from networked device 210 until the time content item 230 is actually starting to be shown or played to a user. The startup delay may vary for the same content item based on, for example, the conditions of the network 240 used to fetch the content item 230 from content source 250, as well as, for example, based on the location of networked device 210 in space relative to a base station of network 240. The startup delay may also be different due to, for example, different content encoding rates that would make the content file larger or smaller, and thus faster or slower to transmit in current network conditions to a networked device 210 at a particular location.

Buffering events occur when a content item 230 has already started to be consumed (e.g., started to be shown or played to a user), but not enough data has been received by networked device 210 from content source 250 to continue the consumption without interruption. For example, if the downloading speed (e.g., the rate at which data is received by networked device 210 from content source 250) is less than the consumption speed (e.g., the rate at which data associated with a song or video is used to play the song or video), buffer under-runs may be induced. That is, for example, a content buffer may run out before the content item has finished being played. During a buffer under-run, content consumption may, for example, be paused and a user may be notified that the content item 230 is buffering an additional portion, or the remainder, of content item 230. The number of such buffering events, and the duration of such buffering events, may impact a user's experience. For example, a high number of buffering events may have a detrimental effect on user experience. Similarly, for example, long buffering events may have a detrimental effect on user experience.

User experience service 270 is configured, for example, similarly or the same as device 300 (e.g., including some or all of the components of device 300 described above). Moreover, while user experience service 270 is graphically depicted as a separate entity, user experience service 270 may be implemented as part of another device. For example, user experience service 270 may be implemented as part of one or more content sources 250. In some embodiments, user experience service 270 includes user experience mapping database 280 and statistical and analytical processing 290. User experience mapping database 280 may be configured to store received user experience reports 260, processed user experience reports (e.g., user experience reports 260 processed by statistical and analytical processing 290), and/or any other data.

For example, statistical and analytical processing 290 may determine, using received user experience reports 260, an expected user experience associated with content item 230 or a category of content item 230 at a plurality of different times of day, at a plurality of different locations, on a plurality of different networks, and/or on a plurality of different types of devices. For example, statistical and analytical processing 290 may determine an average startup delay, an average number of buffering events, and/or an average duration of buffering events for a content item 230. As another example, statistical and analytical processing 290 may determine an average startup delay, an average number of buffering events, and/or an average duration of buffering events for a content item 230 during a plurality of times of day, at a plurality of different locations, when consumed using a plurality of different networks, and/or when consumed using a plurality of different types of device. Statistical and analytical processing 290 may be implemented in software or a combination of software and hardware.

Moreover, user experience service 270 may store data associating different content items 230 with one another. For example, user experience service 270 may store data indicating that two or more content items are different versions of the same content (e.g., the same song or video, but encoded at different bit rates). As another example, user experience service 270 may store data indicating that two or more content items are of the same category (e.g., two or more content items that share some common characteristic, such as a common genre, band, or actor).

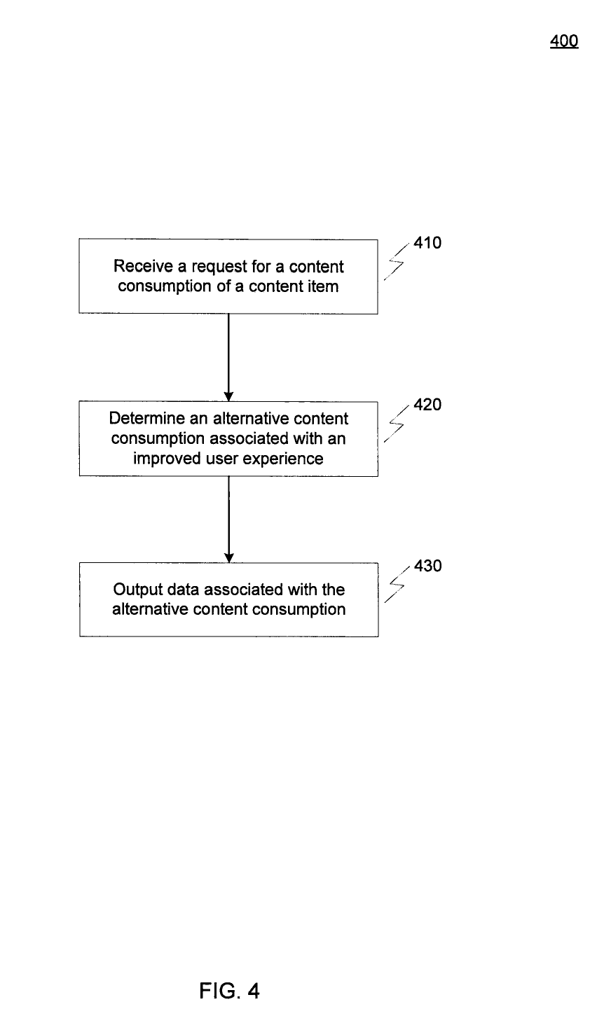

FIG. 4 depicts an example content consumption method 400 for implementing some of the disclosed embodiments. In some embodiments method 400 may be implemented as one or more computer programs executed by a processor. Moreover, in some embodiments, method 400 may be implemented by any device or system, such as networked device 210, content source 250, user experience service 270, or any combination thereof.

Method 400 begins by receiving a request reflecting a content consumption of a content item (step 410). A request reflecting a content consumption of a content item may include any data or information indicative of a request to view, receive, or other interact with a content item. A request reflecting a content consumption of a content item may be received by any device, such as networked device 210, content source 250, or user experience service 270. A request reflecting a content consumption of a content item may include an explicit request reflecting an intent to consume the content item such as, for example, a request submitted by a user to content consumption software 220 to view, play, or otherwise initiate interaction with content item 230. For example, a user may type in the name of content item 230, may select a particular content item 230 from a list of content items 230, or may select a content item 230 in some other way. In some embodiments, the request may initially be received by networked device 210 (e.g., utilizing content consumption software 220). In some embodiments, the request, or data derived from the request, may be forwarded to content source 250 and/or user experience service 270. A request reflecting an intent to consume a content item may also include an implicit request determined, for example, by inferring the request based on usage of an application (e.g., content consumption software 220) by a user.

In other embodiments, a request reflecting a content consumption of a content item may also, or alternatively, include a request submitted at content source 250 or user experience service 270. For example, content source 250 and/or user experience service 270 may include a website that enables a user to submit requests for content consumption of content items.

In some embodiments, the content item associated with the request is determined based on user input. In other embodiments, the content item associated with the request may be determined without any user input. For example, networked device 210 may generate a request reflecting a content consumption of a content item automatically based on data stored in networked device 210. As another example, content source 250 may generate a request reflecting a content consumption of a content item based on data stored in content source 250 (e.g., based on a user profile).

Moreover, in some embodiments, the content item associated with the request is determined from a combination of user input and other data. For example, a user may input data indicative of a request for particular content, but may not indicate other information necessary to identify a particular content item 230. For example, a user may not indicate a version of content that the user wishes to consume (e.g., several different versions of the same content may exist, each having, for example, a different bit rate, level of compression, resolution, etc.). In some embodiments, the request may be associated with all of the versions of the content. In other embodiments, the request may be associated with the highest quality content item 230 (e.g., the content item 230 having the highest bit rate, lowest compression, highest resolution, etc.). In still other embodiments, the request may be associated with a version of content item 230 based on, for example, user preferences. Thus, a request reflecting a content consumption of a content item may identify a particular content item 230 or may identify a group of content items. In some embodiments, a request reflecting a content consumption of a content item may only identify that consumption of some content item is desired, without identifying any particular content. Moreover, in some embodiments, the request may also, or alternatively, include data associated with one or more of a time associated with the request for content consumption (e.g., a time when the request was made or when consumption is intended to occur), a location associated with the request for content consumption (e.g., a location of networked device 210 at a time when the request was made or when consumption is intended to occur), a network associated with the request for content consumption (e.g., a network used by networked device 210 at a time when the request was made or when consumption is intended to occur), and/or a device associated with the request for content consumption (e.g., an identification of the type of device used to submit the request or that is intended to be used when consumption is intended to occur).

Method 400 further includes determining, using at least one processor, an alternative content consumption associated with an improved user experience than the requested content consumption as a function of historical experience data (step 420). The historical experience data may include, for example, data received from user experience service 270 that was generated based on the user experience reports 260. The historical experience data may include, for example, startup delay data associated with the requested content item, number of buffering event data associated with the requested content item, and/or duration of buffering event data associated with the requested content item. The historical experience data may be divided into a plurality of different sets of data, grouped based on, for example, a plurality of different times, a plurality of different locations, a plurality of different networks, and a plurality of different types of devices. The historical experience data may also be associated with a set of past consumptions of one or more different versions of the requested content item. As another example, the historical experience data may also be associated with a set of past consumptions of another content item in a same category as the requested content item. In some embodiments, the historical experience data is derived using a learning algorithm, which may improve upon improvements with content delivery.

The historical experience data may be received (e.g., from user experience service 270) before the request for the content consumption is received. For example, in some embodiments, networked device 210 and/or content source 250 may receive data from user experience service 270 regarding one or more content items 230 regardless of whether a request has been made for a content item (e.g., when content consumption software 220 is installed or on a periodic basis). In other embodiments, the historical experience data may also, or alternatively, be received in response to a request being received. For example, networked device 210 or content source 250 may transmit a request to user experience service 270 for historical experience data associated with the request. For example, historical experience data associated with one or more versions of content items associated with the request, one or more content items in a common category of the request, one or more times of consumption, one or more locations of consumptions, one or more networks used to consume content, and/or one more devices used to consume content.

An alternative content consumption may include, for example, a modification to the requested content consumption. Thus, if a determination is made that a modification can be made to a requested content consumption to achieve an improved user experience, the modification may be applied to determine an alternative content consumption.

For example, a determination may be made based on the historical experience data that at a later time the requested content item can be provided with an improved user experience. The user experience may be based on features affecting playback such as average startup delay, average number of buffering events, average length of buffering events, and/or content bitrate. For example, the user experience may improve if the requested content item can be provided at a later time with a shorter startup delay, a smaller number of buffering events, and/or shorter buffering events. The user experience may also be based on the amount of time into the future that would be required. For example, the user experience may suffer if the amount of time is above a threshold length of time. If a determination is made that at a later time the requested content item can be provided with an improved user experience, the alternative content consumption may be the requested content item provided at the later time.

As another example, a determination may be made based on the historical experience data that a different content item in a same category as the requested content item can be provided with an improved user experience. For example, the historical experience data may be associated with a set of past consumptions of one or more different content items in a common category as the requested content item. The historical experience data may indicate, for example, that that a different content item in the same category as the requested content item (e.g., a content item in the same genre, by the same band, or having a common actor) has an increased user experience than the requested content item. For example, the user experience may improve if the different content item can be provided with a shorter startup delay, a smaller number of buffering events, and/or shorter buffering events. However, in some embodiments, a user experience associated with the non-requested content items may be weighed down to reflect, for example, a user's preference for the requested content item (however, the weighed down user experience may still be higher than that of the requested content item depending on the other factors, such as startup delay, number of buffering events, and/or length of buffering events). If a determination is made that a different content item in a same category as the requested content item can be provided with an improved user experience, the alternative content consumption may be the different content item.

As another example, a determination may be made based on the historical experience data that a different version of the requested content item can be provided with an improved user experience. The historical experience data may indicate, for example, that one version of the content item (e.g., a low resolution version of the content item) has an increased user experience than another version of the content item (e.g., a high resolution version of the content item). For example, the user experience may improve if the different version of the requested content item can be provided with a shorter startup delay, a smaller number of buffering events, and/or shorter buffering events. However, the user experience may also, or alternatively, be based on other factors such as the quality of the version of the content item. For example, a user experience associated with a high resolution version of a content item may be increased by virtue of being associated with the high resolution, but may be decreased if associated with a large startup delay, a large number of buffering events, or long buffering events. Thus, for example, a high resolution version of the content item may have the highest user experience if startup delay, number of buffering events, and length of buffering events are not significantly worse than a low resolution version of the content item. Similarly, for example, a low resolution version of the content item may have the highest user experience if startup delay, number of buffering events, and length of buffering events are significantly worse for the high resolution version of the content item. If a determination is made that a different version of the requested content item can be provided with an improved user experience, the alternative content consumption may be the different version of the requested content item. The different version of the requested content item may be, for example, a lower resolution version of the requested content item.

As another example, a determination may be made based on the historical experience data that the requested content item can be provided with an improved user experience at a different location. For example, the user experience may improve if the requested content item can be provided with a shorter startup delay, a smaller number of buffering events, and/or shorter buffering events at a different location. However, in some embodiments, a user experience associated with the different location may be weighed down to reflect, for example, the need for a user to move locations. If a determination is made that the requested content item can be provided with an improved user experience at a different location, the alternative content consumption may be the requested content item consumed at the different location.

As another example, a determination may be made based on the historical experience data that the requested content item can be provided with an improved user experience on a different network. For example, the user experience may improve if the requested content item can be provided with a shorter startup delay, a smaller number of buffering events, and/or shorter buffering events using the different network. However, the user experience may also be based on other factors. For example, networked device 210 may have access to both a cellular network and a WLAN network. In some embodiments, the costs associated with cellular network may generally cause a lower user experience than the costs associated with a WLAN network, which may or may not be outweighed based on the other factors such as the startup delay, number of buffering events, and/or duration of buffering events. If a determination is made that the requested content item can be provided with an improved user experience on a different network, the alternative content consumption may be the requested content item consumed on the different network.

As another example, a determination may be made based on the historical experience data that the requested content item can be provided with an improved user experience on a different device. For example, the user experience may improve if the requested content item can be provided with a shorter startup delay, a smaller number of buffering events, and/or shorter buffering events using a different device. However, in some embodiments, a user experience associated with the different location may be weighed down to reflect, for example, the need for a user to consume the content item using a different device. The different device may be selected, for example, from a set of devices that a user associated with networked device 210 is known to have access to. For example, a user profile may be stored at networked device 210, content source 250, and/or user experience service 270 indicating what devices a user has access to. If a determination is made that the requested content item can be provided with an improved user experience on a different device, the alternative content consumption may be the requested content item consumed on the different device.

Method 400 further includes outputting data associated with the alternative content consumption (step 430). The outputted data may include, for example, a recommendation to use the alternative content consumption. For example, the outputted data may be displayed on networked device 210 as a selectable option. If the option is selected, consumption of the alternative content consumption may begin immediately, at a scheduled future time, and/or in response to a second user request for the alternative content consumption. As another example, the outputted data may cause consumption of the alternative content consumption to begin automatically using, for example, content consumption software 220.

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, a data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, which is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification (e.g., FIG. 4) can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

1. A computer-implemented method for user experience based content consumption, comprising:
receiving a request reflecting a content consumption of a content item;
determining, using at least one processor, an alternative content consumption associated with an improved user experience than the requested content consumption as a function of historical experience data; and
outputting data associated with the alternative content consumption.

2. The method of claim 1, wherein the historical experience data includes data determined based on a plurality of past consumptions of the requested content item at one or more of a plurality of locations, at a plurality of times, on a plurality of networks, or on a plurality of devices.

3. The method of claim 1, wherein the historical experience data includes data determined based on a set of past consumptions of a different version of the requested content item.

4. The method of claim 1, wherein the historical experience data includes data determined based on a set of past consumptions of another content item in a same category as the requested content item.

5. The method of claim 1, wherein the historical experience data includes startup delay data associated with the requested content item.

6. The method of claim 1, wherein the historical experience data includes number of buffering event data associated with the requested content item.

7. The method of claim 1, wherein the historical experience data includes duration of buffering event data associated with the requested content item.

8. The method of claim 1, further comprising:
determining, based on the historical experience data, that at a later time the requested content item can be provided with an improved user experience,
wherein the alternative content consumption is the requested content item provided at the later time.

9. The method of claim 1, further comprising:
determining, based on the historical experience data, that a different content item in a same category as the requested content item can be provided with an improved user experience,
wherein the alternative content consumption is the different content item.

10. The method of claim 1, further comprising:
determining, based on the historical experience data, that a different version of the requested content item can be provided with an improved user experience,
wherein the alternative content consumption is the different version of the requested content item.

11. The method of claim 1, wherein the different version of the requested content item is a lower resolution version of the requested content item.

12. The method of claim 1, further comprising:
determining, based on the historical experience data, that the requested content item can be provided with an improved user experience at a different location,
wherein the alternative content consumption is the requested content item consumed at the different location.

13. The method of claim 1, further comprising:
determining, based on the historical experience data, that the requested content item can be provided with an improved user experience on a different network,
wherein the alternative content consumption is the requested content item consumed on the different network.

14. The method of claim 1, further comprising:
determining, based on the historical experience data, that the requested content item can be provided with an improved user experience on a different device,
wherein the alternative content consumption is the requested content item consumed on the different device.

15. The method of claim 1, further comprising:
determining, based on the historical experience data, at least one of the following:
that at a later time the requested content item can be provided with an improved user experience,
that a different content item in a same category as the requested content item can be provided with the improved user experience,
that a different version of the requested content item can be provided with the improved user experience,
that the requested content item can be provided with the improved user experience at a different location,
that the requested content item can be provided with the improved user experience on a different network, or
that the requested content item can be provided with the improved user experience on a different device,
wherein the improved user experience includes at least one of the following: a shorter startup delay, fewer buffering events, or shorter buffering events.

16. The method of claim 1, wherein outputting the data associated with the alternative content consumption includes outputting a notification that the alternative content consumption is available, and wherein the method further comprises:
receiving a user selection associated with the notification; and
outputting content associated with the alternative content consumption.

17. The method of claim 1, wherein outputting the data associated with the alternative content consumption includes outputting content associated with the alternative content consumption.

18. The method of claim 1, wherein receiving the request reflecting the content consumption of the content item includes receiving an explicit request reflecting an intent to consume the content item.

19. The method of claim 1, wherein receiving the request reflecting the content consumption of the content item includes inferring the request based on usage of an application by a user.

20. A system for user experience based content consumption, comprising:
at least one processor;
at least one memory device that includes instructions which, when executed by the at least one processor, configure the at least one processor to:
receive a request reflecting a content consumption of a content item;
determine an alternative content consumption associated with an improved user experience than the requested content consumption as a function of historical experience data; and
output data associated with the alternative content consumption.

21. The system of claim 20, wherein the historical experience data includes data determined based on a plurality of past consumptions of the requested content item at one or more of a plurality of locations, at a plurality of times, on a plurality of networks, or on a plurality of devices.

22. The system of claim 20, wherein the historical experience data includes data determined based on a set of past consumptions of a different version of the requested content item.

23. The system of claim 20, wherein the historical experience data includes data determined based on a set of past consumptions of another content item in a same category as the requested content item.

24. The system of claim 20, wherein the historical experience data includes startup delay data associated with the requested content item.

25. The system of claim 20, wherein the historical experience data includes number of buffering event data associated with the requested content item.

26. The system of claim 20, wherein the historical experience data includes duration of buffering event data associated with the requested content item.

27. A non-transitory computer-readable medium comprising instructions that, when executed by at least one processor, cause the at least one processor to perform operations including:
receiving a request reflecting a content consumption of a content item;
determining an alternative content consumption associated with an improved user experience as a function of historical experience data; and
outputting data associated with the alternative content consumption.

28. The non-transitory computer-readable medium of claim 27, wherein the historical experience data includes data determined based on a plurality of past consumptions of the requested content item at one or more of a plurality of locations, at a plurality of times, on a plurality of networks, or on a plurality of devices.

29. The non-transitory computer-readable medium of claim 27, wherein the historical experience data includes data determined based on a set of past consumptions of a different version of the requested content item.

30. The non-transitory computer-readable medium of claim 27, wherein the historical experience data includes data determined based on a set of past consumptions of another content item in a same category as the requested content item.

31. The non-transitory computer-readable medium of claim 27, wherein the historical experience data includes startup delay data associated with the requested content item.

32. The non-transitory computer-readable medium of claim 27, wherein the historical experience data includes number of buffering event data associated with the requested content item.

33. The non-transitory computer-readable medium of claim 27, wherein the historical experience data includes duration of buffering event data associated with the requested content item.
